(19) United States
(12) Patent Application Publication
(10) Pub. No.: US 2012/0291932 A1
(43) Pub. Date: Nov. 22, 2012

(54) Oval and Asymmetric Wheels for Luggage Bags

(76) Inventor: James Pan, Costa Mesa, CA (US)

(21) Appl. No.: 13/113,053

(22) Filed: May 22, 2011

(51) Int. Cl. B60B 33/00

(52) U.S. Cl. 152/5

(57) ABSTRACT

The present invention is about an oval or asymmetric wheel design for luggage bags. The wheel is in an ellipsoidal configuration. Suspension, cushion, or elastic devices are installed in the oval wheels. These devices, when compressed by the weight of the luggage bag, store energy. When the luggage bag is shifted in the subsequent phase of the motion by the traveler, the energy in the devices is released from the cushion, and pushes the luggage toward the intended direction.

### FIELD OF THE INVENTION

The present invention relates generally to wheels, and more particularly, to wheels of travelers' luggage bags.

### BACKGROUND OF THE INVENTION

The present invention describes luggage wheels with special designs to take advantage of the weight of the luggage bag, which can save and release energy from gravity.

The newly designed wheels include suspension systems installed in various parts of the reconfigured wheels.

Without such suspension systems, the person carrying the luggage bag needs to cope with not only the weight of the bag but also the friction between the wheels and the ground.

The suspension systems of the wheels convert the energy from gravity and the force from the friction with the ground to energies or forces that help the traveler move the luggage bag forward.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention provides luggage bag wheels with various configurations and suspensions. The suspension devices not only protect the luggage from bumpy grounds, but also save the work done by gravity and friction and convert it to energy. When the energy is released, forward and up lifting forces are produced to help the traveler move the luggage.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 shows an oval wheel with suspension devices attached along the longer diameters.

FIG. 2 describes a wheel with two coaxial rings. The inner ring is oval. The outer ring is circular. There are suspension devices attached in between the two rings.

FIG. 3 describes a wheel with two coaxial rings. The inner ring is circular. The outer ring is oval. There are suspension devices attached in between the two rings.

FIG. 4 shows a wheel with multiple rings and multiple suspension devices in between the rings.

FIG. 5 shows a wheel with an adjustable suspension device between the rim and the axis. The axis may or may not located at the center of the wheel.

FIG. 6 shows a telescope type suspension device with the sections connected by springs.

FIG. 7 illustrates a wheel with two axes and two shafts. A suspension device connects the two shafts. One is called main shaft. The other is called floating shaft.

FIG. 8 shows a wheel with multiple axes connected by suspension devices.

FIG. 9 shows a solid wheel—the disc is divided to different sections connected by suspension devices.

FIG. 10 shows a wheel with multiple separate sections in the rim. The sections are attached to different axes. There are suspension devices connecting the separate sections in the rim.

FIG. 11 teaches a wheel with a triangular suspension device.

FIG. 12 describes a wheel with a thicker suspension device in the back and a thinner suspension device in the front.

FIG. 13 shows a divided wheel connected by cushions and springs. The notches shown in the figure at the ends of the dividing line is to reduce the friction between the wheel and the ground. There are triangular-shape cushion devices in the notch to conserve energy from friction and gravity.

### DETAILED DESCRIPTION OF THE INVENTION

The present invention will now be described with respect to the accompanying drawings in which like numbered elements represent like parts. The figures provided herewith and the accompanying description of the figures are merely provided for illustrative purposes. One of ordinary skill in the art should realize, based on the instant description, other implementations and methods for fabricating the devices and structures illustrated in the figures and in the following description.

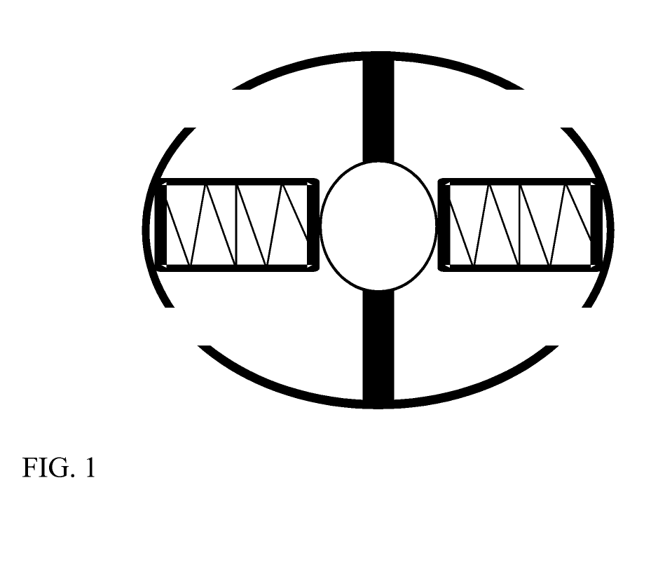

The luggage wheel in FIG. 1 is in oval shape. The weight of the luggage, naturally from gravity, presses along the longer diameter of the oval wheel. Energy is saved in the suspension device from the work done by the weight of the luggage from gravity. This energy is released when the luggage bag is shifted, pushing the luggage bag forward without applying more forces by the traveler.

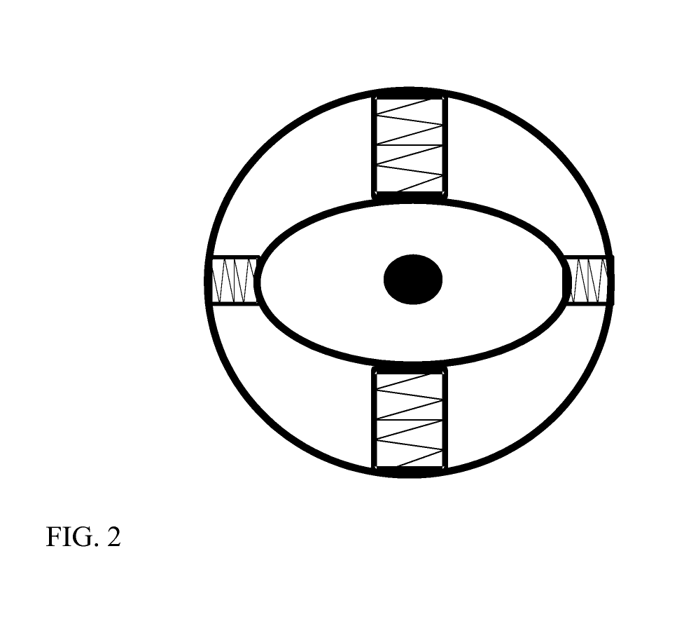

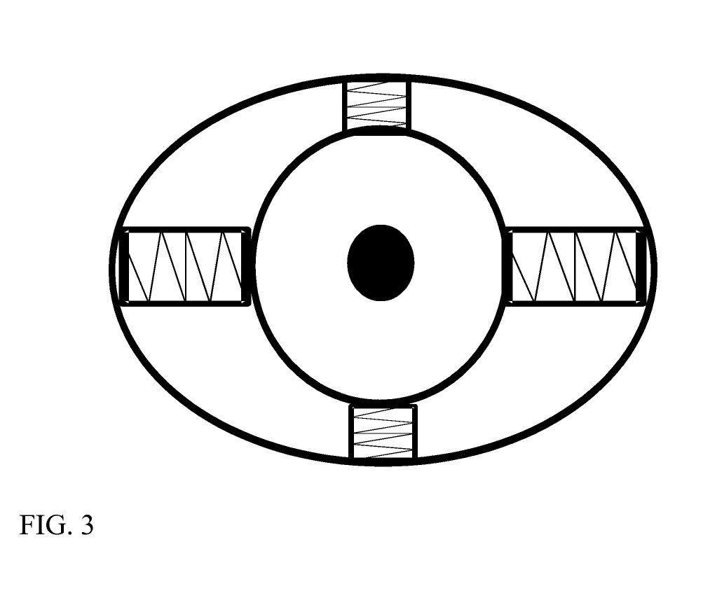

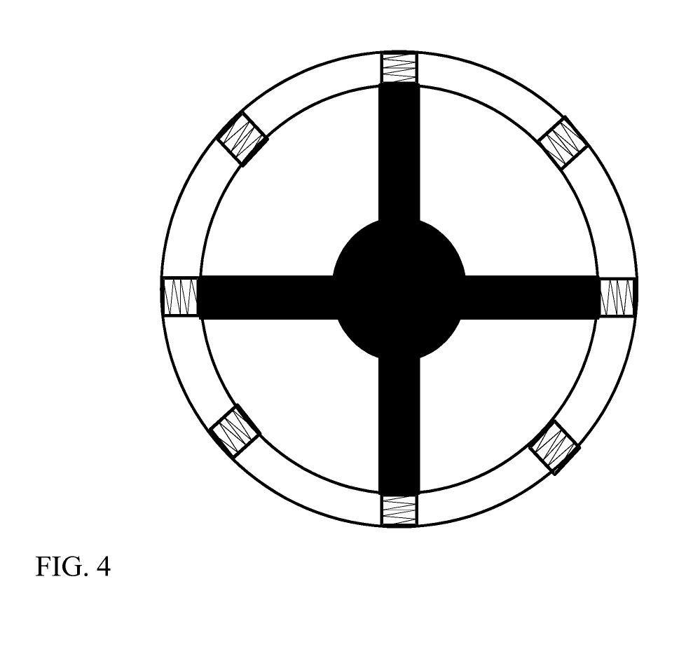

The same principle applies to the wheels in FIG. 2, FIG. 3 and FIG. 4. There are multiple rings (2 rings are shown in the figures). In between the 2 rings of circular or oval shapes, there are suspension devices. Work is done by the weight of the luggage. Energy is released when the luggage is shifted, pushing the bag forward without more forces by the traveler.

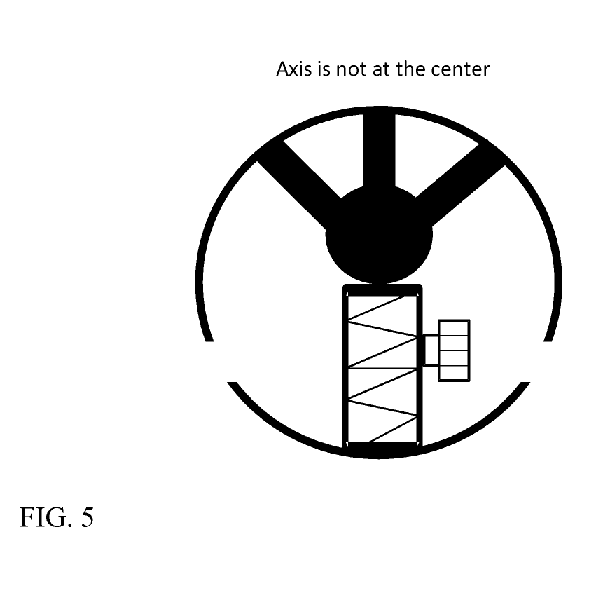

In FIG. 5 the axis may or may not be located in the center of the wheel. There is a suspension device installed, as shown in the figure. The length and strength of the suspension device is adjustable.

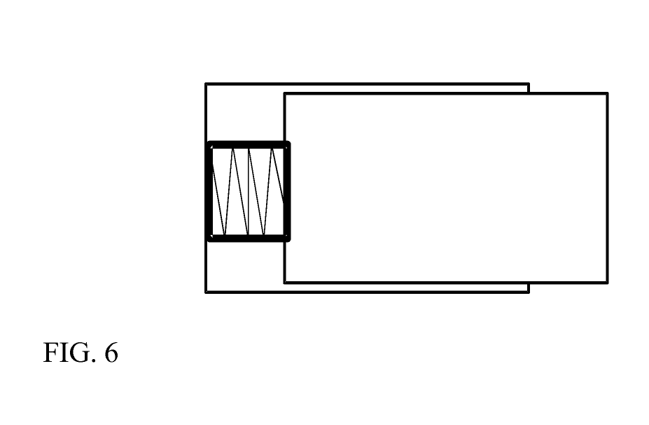

This is a telescope type of structure in FIG. 6. An elastic device (a spring) connects the two sections. This telescope type of suspension device provides more strength than just the spring along, while maintaining the cushion through the spring inside. The total length is adjustable due to the multiple sections in the telescope structure.

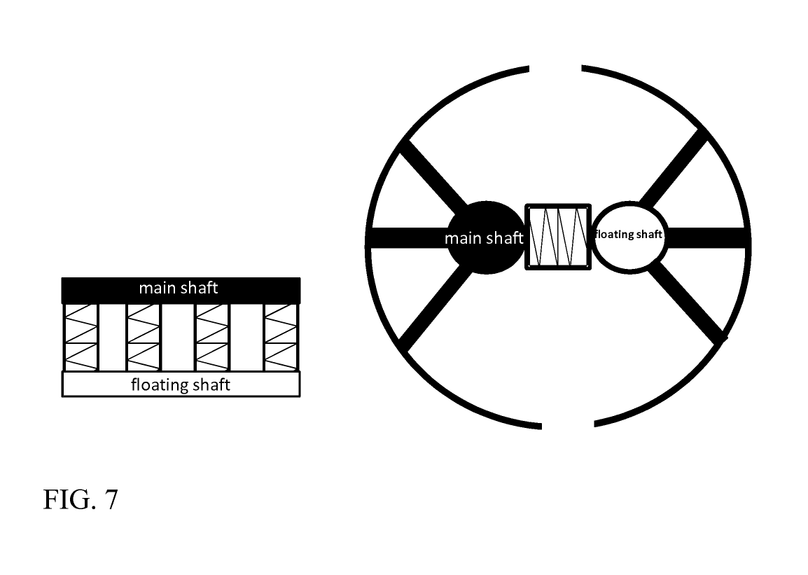

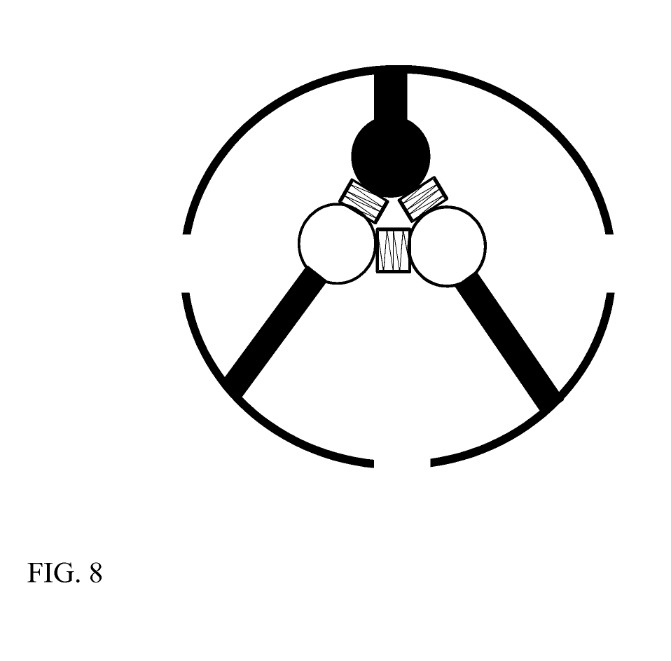

In FIG. 7 and FIG. 8, multiple shafts are introduced. There are suspension devices in between the shafts. In FIG. 7 one shaft is called the “main shaft”, attached to the luggage. The other shaft is called “floating shaft”, attached to the main shaft only through the suspension devices. When the traveler drags the luggage, work is done by the weight of the luggage bag, and energy is saved and released by the suspension devices in between the shafts.

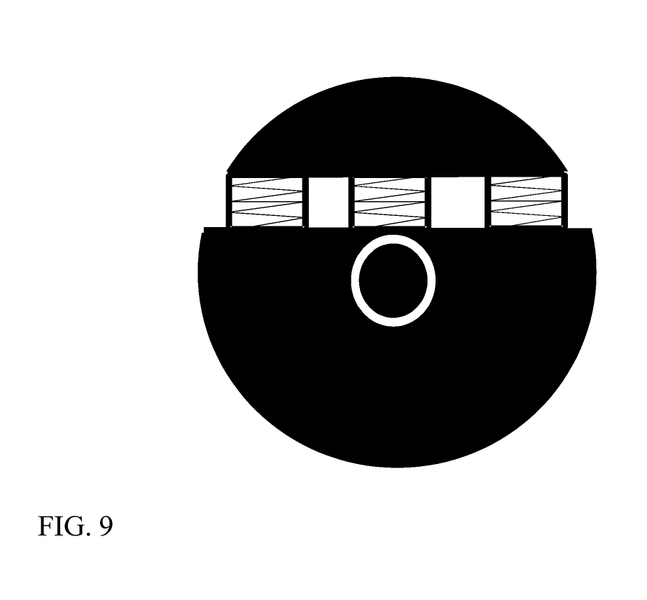

FIG. 9 shows a solid wheel divided to two (or multiple) sections. Suspension devices are installed in between the sections. Energy is saved in these suspension devices when they are compressed by the weight of the luggage, and released when the luggage is moved forward.

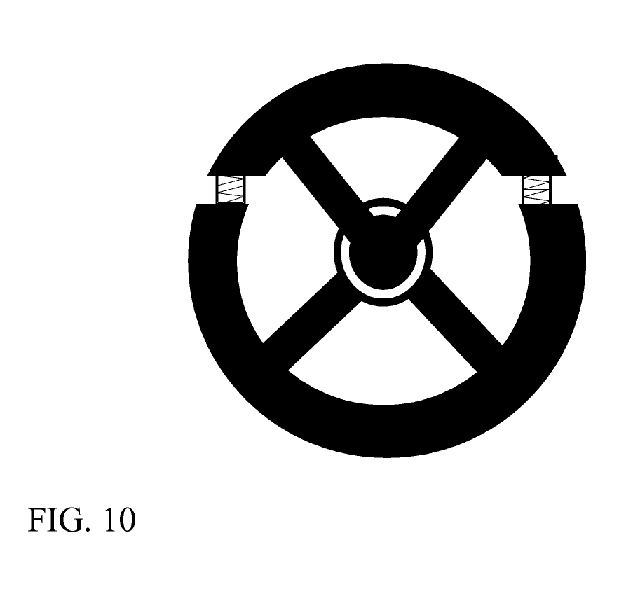

In FIG. 10 the ring of the wheel is divided to multiple sections, connected by suspension devices. It works as the wheels in previous figures—saving energy from gravity in the springs to push the luggage forward. The difference is: the system not only saves the energy from gravity, but also conserves energy from the friction between the wheels and the floors.

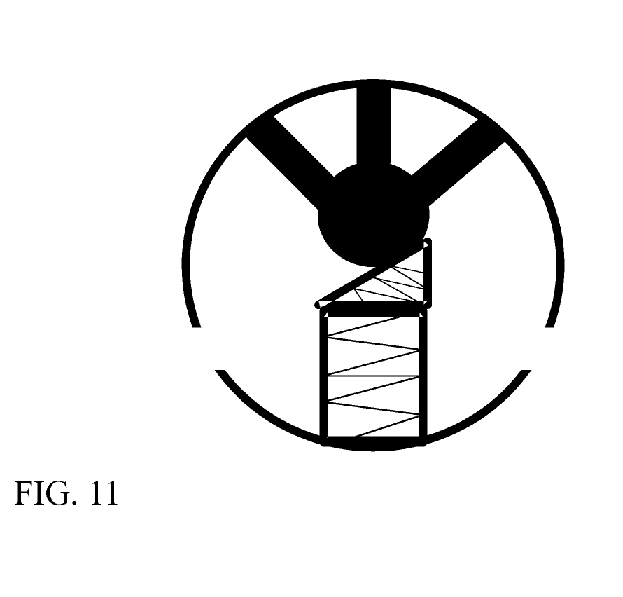

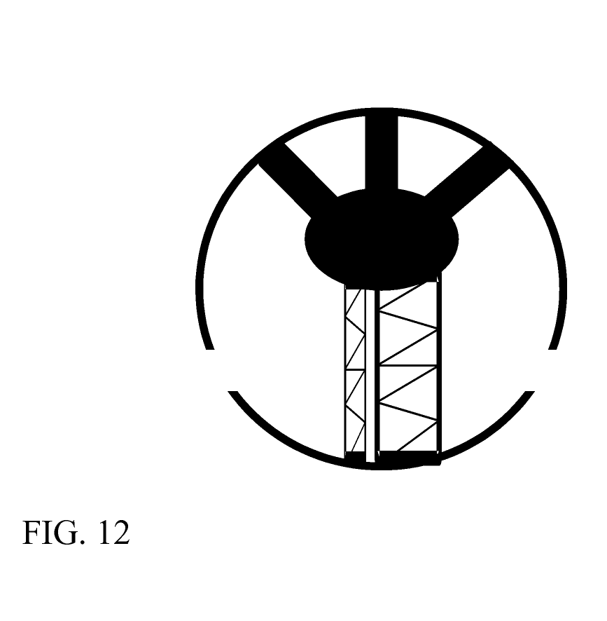

FIGS. 11 and 12 describe wheels with the suspension device that can further push the luggage specifically in the forward direction. The suspension device is in a triangular shape in FIG. 11. When the weight of the luggage applies a downward force to the suspension system, the triangular device saves the energy. When this energy is released, more forces come from the back of the suspension system, resulting in a forward pushing force on the luggage. In FIG. 12, there are two sections in the suspension system—one in the back is stronger than the one in the front. When energy from the gravity is released from the two springs, more forces come from the back suspension device, resulting in a forward pushing force on the luggage.

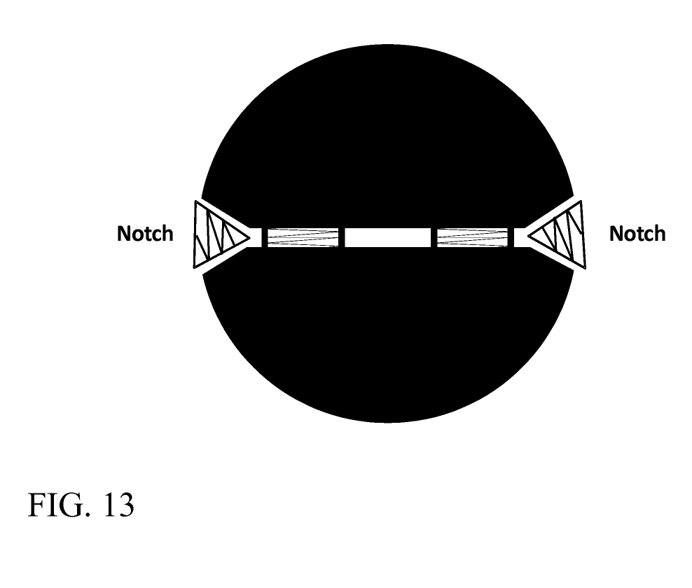

FIG. 13 shows a divided wheel with notches at the ends of the dividing lines. The notches are to reduce the friction with the ground. The triangular springs inside the notches are to save the work done by the friction forces and gravity during rotation of the wheel, and convert it to energy when the springs are released.

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

1. An oval wheel attached to a luggage bag comprises: a rim that is separated to several sections, with cushions, or springs, or suspension devices connecting the separate sections in the rim to the central axis.

2. The wheel of claim 1, wherein multiple oval or circular rims are in a coaxial configuration with overlapping centers or non-overlapping centers, and the outer rims and the inner rims are connected with cushions, springs or other elastic suspension devices.

3. The wheel of claim 1, wherein multiple shafts are connected with cushions or suspension devices, and the multiple shafts are connected to the multiple sections in the rim.

4. The wheel of claim 1, wherein the entire wheel is divided to multiple sections, with cushions or suspension devices connecting each section of the wheel.

5. The wheel of claim 1, wherein the rim is divided to multiple sections, with cushions or suspension devices connecting a section of the rim to the sections next to it.

6. The wheel of claim 1, wherein the suspension device comprises multiple telescope-like sections, with a spring or cushion connecting the adjacent two sections.

7. The wheel of claim 1, wherein the suspension system, which connects the axis to the rim section, comprises a stronger, longer or thicker back sub-system and a relatively weaker, shorter or thinner front sub-system, or a triangular spring or cushion device, and releases more forces from the section facing the back of the luggage bag, and less forces from the section facing the front of the luggage bag, when compressed by the weight of the luggage.

8. The wheel of claim 1-7, wherein the wheel is divided to two or more sections, with springs or other types of suspension devices connecting the sections, and there are notches in the edge of the wheel at the ends of each dividing lines, to reduce friction between the wheel and the ground, and the notches are filled with triangular-shape springs or triangular suspension devices.
